(19) United States
(12) Patent Application Publication
(10) Pub. No.: US 2012/0105408 A1
(43) Pub. Date: May 3, 2012

(54) Organic light emitting display

(76) Inventor: Chul-Kyu Kang, Yongin-City (KR)

(21) Appl. No.: 13/067,252

(22) Filed: May 19, 2011

(30) Foreign Application Priority Data
Oct. 28, 2010 (KR) 10-2010-0105799

(51) Int. Cl. G09G 5/00

(52) U.S. Cl. 345/211

(57) ABSTRACT

An organic light emitting display, in which one frame is divided into an initializing period, a compensation period, a scan period, and an emission period, includes pixels at intersections of scan lines and data lines, the pixels coupled to a first power source and a second power source, a scan driver simultaneously supplying scan signals to the scan lines for a partial period of the initializing period, the scan driver simultaneously supplying scan signals to the scan lines for the compensation period, and the scan driver sequentially supplying scan signals to the scan lines for the scan period, a data driver supplying data signals to the data lines in synchronization with the scan signals supplied for the scan period, and a first power source driver supplying the first power source, the first power source having different voltage levels for the initializing period, the scan period, and the emission period.

### BACKGROUND

1. Field

Embodiments relate to an organic light emitting display. More particularly, the embodiments relate to an organic light emitting display capable of simplifying the structure and of compensating for the threshold voltages of driving transistors.

2. Description of the Related Art

High weight and large volume are disadvantages of cathode ray tubes (CRT). Recently, various flat panel displays (FPD) have been developed that are capable of reducing weight and volume. The FPDs include a liquid crystal display (LCD), a field emission display (FED), a plasma display panel (PDP), and an organic light emitting display.

Among the FPDs, the organic light emitting display displays an image using organic light emitting diodes (OLED), that generate light by re-combination of electrons and holes. The organic light emitting display has high response speed and is driven with low power consumption.

### SUMMARY

Embodiments are directed to an organic light emitting display.

Embodiments may be realized by providing an organic light emitting display in which one frame is divided into an initializing period, a compensation period, a scan period, and an emission period to be driven, including pixels at intersections of scan lines and data lines, the pixels coupled to a first power source and a second power source, a scan driver simultaneously supplying scan signals to the scan lines for a partial period of the initializing period, the scan driver simultaneously supplying scan signals to the scan lines for the compensation period, and the scan driver sequentially supplying scan signals to the scan lines for the scan period, a data driver supplying data signals to the data lines in synchronization with the scan signals supplied for the scan period, and a first power source driver for supplying the first power source, the first power source having different voltage levels for the initializing period, the scan period, and the emission period.

Each of the pixels may include an organic light emitting diode with a cathode electrode coupled to the second power source, a first transistor for controlling an amount of current that flows from the first power source to the second power source via the OLED, a second transistor coupled between a gate electrode of the first transistor and the OLED and turned on when a scan signal is supplied to a scan line, and a storage capacitor coupled between the gate electrode of the first transistor and a data line. The first power source driver may supply an initializing voltage as the first power source so that the pixels may be set to be in a non-emission state for the initializing period, the first power source driver may supply a higher reference voltage than the initializing voltage for the compensation period and the scan period, and the first power source driver may supply a higher level voltage than the reference voltage so that the pixels may be set to be in an emission state for the emission period.

The initializing period may be divided into a first period, a second period, and a third period and the data driver may supply a third voltage to data lines for a first period and a second period of the initializing period, the data driver may supply a fourth voltage lower than a third voltage for the third period. A voltage difference between the third voltage and the fourth voltage may be set so that the first transistor may be turned on. The fourth voltage may be set to be equal to or lower than a data signal. The data driver may supply the third voltage to the data lines for the emission period. The data driver may set the data lines in a floating state for the emission period.

The scan driver may simultaneously supply scan signals to scan lines for the second period. The organic light emitting display further may include an emission control line commonly coupled to the pixels. Each of the pixels may further include a third transistor coupled between the first power source and the data line, the third transistor turned off when an emission control signal is supplied to the emission control line, and the third transistor turned on in the other cases. The scan driver may supply an emission control signal to the emission control line for the initializing period, the compensation period, and the scan period.

Each of the pixels may include a third transistor coupled between the storage capacitor and the first power source, the third transistor turned off when an emission control signal is supplied to the emission control line and a fourth transistor coupled between the storage capacitor and the data line, the fourth transistor turned on when the scan signal is supplied. The initializing period may be divided into a first period, a second period, and a third period and the data driver may supply a third voltage for the second period of the initializing period, the data driver may supply a fourth voltage lower than the third voltage for the first period and the second period.

### BRIEF DESCRIPTION OF THE DRAWINGS

The accompanying drawings, together with the specification, illustrate exemplary embodiments, and, together with the description, serve to explain the principles of the exemplary embodiments.

FIG. 1 illustrates an organic light emitting display according to an embodiment;

FIG. 2 illustrates a first embodiment of the pixel of FIG. 1;

FIG. 3 is a waveform chart illustrating a method of driving the pixel of FIG. 2;

FIG. 4 illustrates a second embodiment of the pixel of FIG. 1;

FIG. 5 is a waveform chart illustrating a method of driving the pixel of FIG. 4;

FIG. 6 illustrates an organic light emitting display according to another embodiment;

FIG. 7 illustrates an embodiment of the pixel of FIG. 6;

FIG. 8 is a waveform chart illustrating a method of driving the pixel of FIG. 7; and

FIG. 9 illustrates a conventional pixel.

### DETAILED DESCRIPTION

Korean Patent Application No. 10-2010-0105799, filed on Oct. 28, 2010, in the Korean Intellectual Property Office, and entitled: “Organic Light Emitting Display Device” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be through and complete, and will fully convey the scope of the inventive concept to those skilled in the art.

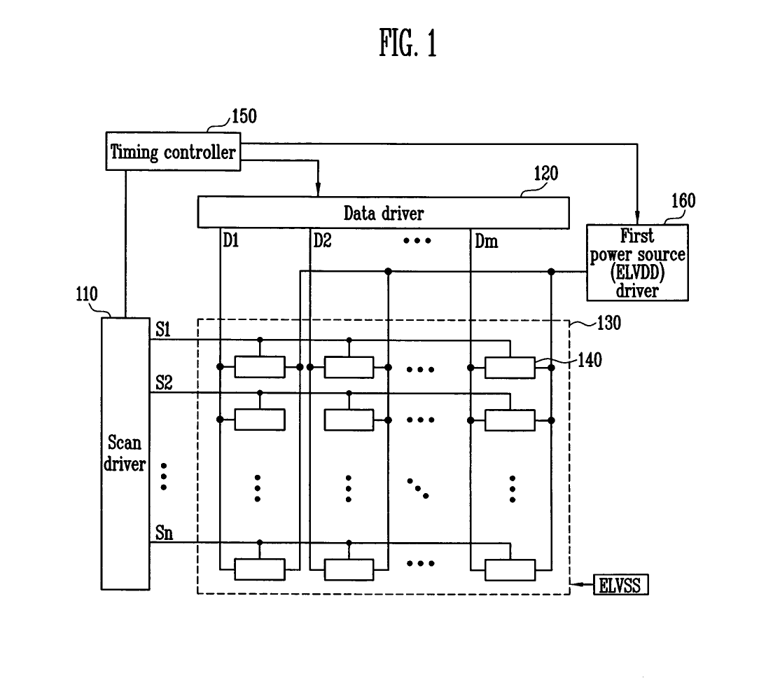

FIG. 1 illustrates an organic light emitting display according to an embodiment.

Referring to FIG. 1, the organic light emitting display, according to the embodiment, includes a pixel unit 130, a scan driver 110 for driving the scan lines S1 to Sn, a data driver 120 for driving the data lines D1 to Dm, a first power source driver 160 for applying a first power source ELVDD to the pixels 140, and a timing controller 150 for controlling the drivers 110, 120, and 160. The pixel unit 130 includes pixels 140 positioned at the intersections of scan lines S1 to Sn and data lines D1 to Dm.

The pixels 140 are coupled to the first power source ELVDD and a second power source ELVSS. Each of the pixels 140 generates light with predetermined brightness. The pixels 140 also control the amount of current that flows from the first power source ELVDD to the second power source ELVSS, via an organic light emitting diode (OLED), to correspond to data signals.

The first power source driver 160 generates the first power source ELVDD to supply the first power source ELVDD to the pixels 140. The first power source driver 160 changes the voltage of the first power source ELVDD. The voltage of the first power source ELVDD is changed for a specific period, i.e., one frame.

As illustrated in FIG. 3, the first power source driver 160 supplies an initializing voltage Vint, of a sufficiently low level, so that the OLED is set to be in a non-emission state for an initializing period of one frame (1F). The first power source driver 160 supplies a higher reference voltage Vref than the initializing voltage Vint for a compensation period and a scan period. Then, the first power source driver 160 supplies a higher level voltage than the reference voltage Vref, so that the OLED is set to be in an emission state for an emission period.

The voltage of the first power source ELVDD changes into the initializing voltage, the reference voltage, and the high level voltage. The voltage of the second power source ELVSS is maintained at a low level voltage (i.e., a ground voltage) for one frame.

The scan driver 110, sequentially or simultaneously, supplies scan signals to the scan lines S1 to Sn for one frame. The scan driver 110 supplies three scan signals, SS1, SS2, and SS3, to the scan lines S1 to Sn for one frame.

The scan driver 110 simultaneously supplies the first scans signal SS1 to the scan lines S1 to Sn for a second period T2. The second period T2 is part of the initializing period. The scan driver 110 simultaneously supplies the second scan signal SS2 to the scan lines S1 to Sn for the compensation period. The scan driver 110 sequentially supplies the third scan signal SS3 to the scan lines S1 to Sn for a scan period.

The data driver 120 supplies data signals to the data lines D1 to Dm in synchronization with the third scan signal SS3, for the scan period. Then, the data driver 120 supplies a third voltage V3, to the data lines D1 to Dm, for a first period T1 and a second period T2 of the initializing period. The data driver 120 supplies a fourth voltage V4, lower than the third voltage V3, for a third period T3.

The timing controller 150 controls the scan driver 110, the data driver 120, and the first power source driver 160 to correspond to the outside supplied synchronizing signals.

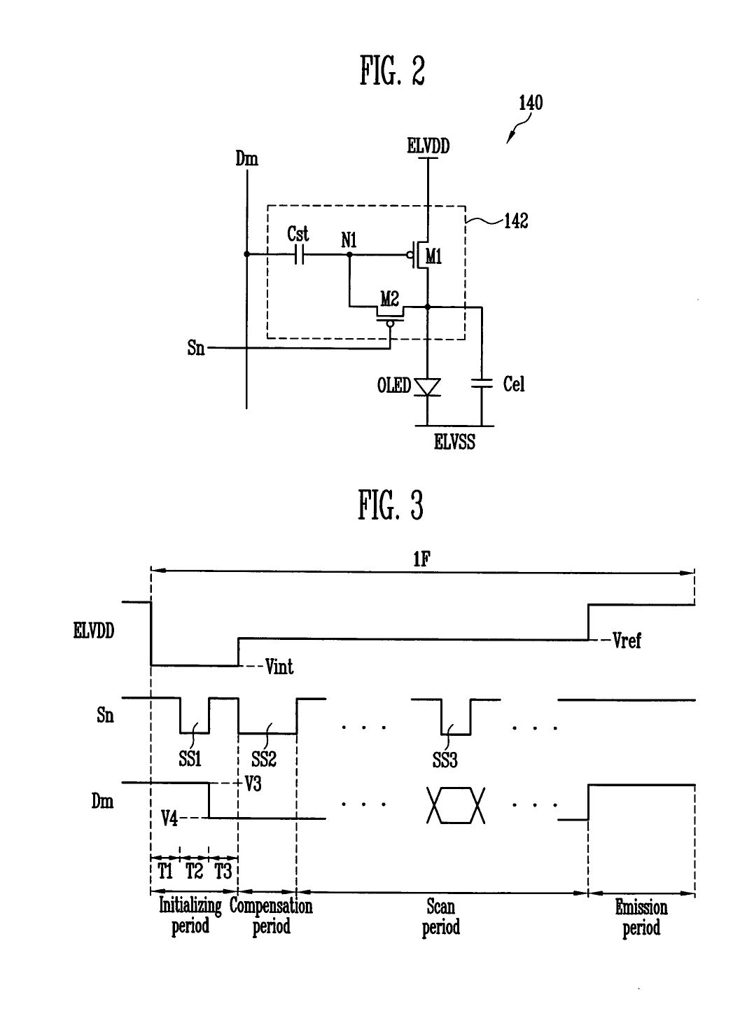

FIG. 2 illustrates a pixel according to a first embodiment. In FIG. 2, the pixel is coupled to the nth scan line Sn and the mth data line Dm.

Referring to FIG. 2, the pixel 140, according to the first embodiment, includes an organic light emitting diode (OLED) and a pixel circuit 142. The pixel circuit 142 is coupled to the data line Dm and the scan line Sn to control the amount of current supplied to the OLED.

The anode electrode of the OLED is coupled to the pixel circuit 142. The cathode electrode of the OLED is coupled to a second power source ELVSS. The OLED generates light with predetermined brightness, to correspond to the amount of current supplied from the pixel circuit 142, for an emission period.

When a scan signal is supplied, the pixel circuit 142 receives a data signal from the data line Dm. The pixel circuit 142 controls current that flows from a first power source ELVDD to the second power source ELVSS. The current flows from a first power source ELVDD to the second power source ELVSS, via the OLED, to correspond to the received data signal. The pixel circuit 142 includes a first transistor M1, a second transistor M2, and a storage capacitor Cst.

The storage capacitor Cst is coupled between the data line Dm and a first node N1. The storage capacitor Cst charges the voltages corresponding to the data signal and the threshold voltage of the first transistor M1.

The first electrode of the first transistor M1 is coupled to the first power source ELVDD. The second electrode of the first transistor M1 is coupled to the OLED. The gate electrode of the first transistor M1 is coupled to the first node N1. The first transistor M1 supplies current corresponding to the voltage applied to the first node N1 to the OLED.

The first electrode of the second transistor M2 is coupled to the second electrode of the first transistor M1. The second electrode of the second transistor M2 is coupled to the first node N1. The gate electrode of the second transistor M2 is coupled to the scan line Sn. The second transistor M2 is turned on when the scan signal is supplied to the scan line Sn. The scan signal is supplied to the scan line Sn to electrically couple the first node N1 to the second electrode of the first transistor M1.

The capacitor Cel, illustrated in FIG. 2, is the parasitic capacitor of the OLED. The parasitic capacitor Cel is set to have a higher capacity than the storage capacitor Cst.

FIG. 3 is a waveform chart illustrating a method of driving the pixel of FIG. 2.

Referring to FIG. 3, according to the present embodiments, one frame 1F is divided into an initializing period, a compensation period, a scan period, and an emission period. The initializing period is where the voltage of the first node N1 is initialized. The compensation period is where the threshold voltage of the first transistor M1 is compensated for. The scan period is where the voltages corresponding to data signals are charged. The emission period is where the light components corresponding to the data signals are generated.

The initializing period is divided into a first period T1 to a third period T3. An initializing voltage Vint is the first power source ELVDD, supplied during the first period T1 to the third period T3. For the first period T1 and the second period T2 of the initializing period, the third voltage V3 is supplied to the data line Dm. For the third period, the fourth voltage V4 is supplied.

For the first period T1 of the initializing period, the initializing voltage Vint is supplied to the first power source ELVDD. When the initializing voltage Vint is supplied to the first power source ELVDD, the OLED is set to be in a non-emission state.

For the second period T2 of the initializing period, the first scan signal SS1 is simultaneously supplied to the scan lines S1 to Sn. When the first scan signal SS1 is supplied to the scan line Sn, the second transistor M2 is turned on. When the second transistor M2 is turned on, the voltage of the anode electrode of the OLED is supplied to the first node N1. Since the OLED is set to be in an off state for the initializing period, the off voltage of the OLED is supplied to the first node N1.

For the third period T3 of the initializing period, the fourth voltage V4 is supplied to the data line Dm. For the third period T3, the voltage of the data line Dm is reduced from the third voltage V3 to the fourth voltage V4. When the voltage of the data line Dm is reduced, the voltage of the first node N1 is reduced by the coupling of the storage capacitor Cst to correspond to the reduction of the voltage of the data line Dm. A voltage difference between the third voltage V3 and the fourth voltage V4 is set so that the first transistor M1 may be turned on by the voltage of the first node N1. Then, the fourth voltage V4 is set to be equal to or lower than the data signal.

When the voltage of the first node N1 is reduced, the first transistor M1 is turned on. When the first transistor M1 is turned on, the initializing voltage Vint is supplied to the anode electrode of the OLED. Thus, the initializing voltage Vint is charged in the parasitic capacitor Cel.

For the compensation period, the second scan signal SS2 is simultaneously supplied to the scan lines S1 to Sn. For the compensation period, the voltage of the reference power source Vref is supplied to the first power source ELVDD. When the second scan signal SS2 is supplied to the scan line Sn, the second transistor M2 is turned on. When the second transistor M2 is turned on, the first node N1 and the anode electrode of the OLED are electrically coupled to each other. The voltage of the first node N1 is reduced to the initializing voltage Vint by the initializing voltage Vint charged in the parasitic capacitor Cel. The parasitic capacitor Cel is set to have a capacity about ten times larger than the capacity of the storage capacitor Cst.

When the voltage of the reference power source Vref is supplied to the first power source ELVDD, the voltage of the first node N1 increases from the initializing voltage Vint to the voltage obtained by subtracting the threshold voltage of the first transistor M1 from the reference power source Vref. The storage capacitor Cst charges a predetermined voltage to correspond to the voltage applied to the first node N1.

For the scan period, the third scan signal SS3 is sequentially supplied to the scan lines S1 to Sn. Data signals are supplied to the data lines D1 to Dm to correspond to the third scan signal SS3.

For a period where the third scan signal SS3 is supplied to the first scan line S1 to the (n−1)th scan line Sn−1, the voltage of the data line Dm changes to correspond to the data signal. Since the first node N1 of each of the pixels 140, positioned in the nth horizontal line, is set to be floated, the storage capacitor Cst maintains the voltage charged in the compensation period.

When the third scan signal SS3 is supplied to the nth scan line Sn, the first node N1 and the anode electrode of the OLED are electrically coupled to each other. The data signal is supplied to the data line Dm in synchronization with the third scan signal SS3. When the data signal is supplied to the data line Dm, the data line Dm increases from the fourth voltage V4 to the voltage of the data signal. When the voltage of the data line Dm changes, the voltage of the first node N1 changes. The change in voltage of the first node N1 is illustrated in Equation 1 below:

$${V}_{N 1} = Vref - \vert Vth \vert + \frac{Cel\_Cst}{Cst} \times Δ Vdata$$

In Equation 1, Vth represents the threshold voltage of the first transistor M1. ΔVdata represents the voltage change amount of the data line Dm.

In Equation 1, since the capacities of the parasitic capacitor Cel and the storage capacitor Cst are set to be fixed values, the voltage applied to the first node N1 is determined by the data signal. The storage capacitor Cst charges a predetermined voltage to correspond to the voltage applied to the first node N1. The voltage of the data signal is set to be equal to or higher than the fourth voltage V4. Therefore, since the voltage of the first node N1 is equal to or higher than the compensation period for the scan period, the first transistor M1 maintains a turn off state for the scan period.

For the emission period, a higher level voltage than the reference power source Vref is supplied to the first power source ELVDD. For the emission period, the voltage of the data line Dm is set to either the third power source V3 or a floating state. When the voltage of the data line Dm changes, the second transistor M2 maintains a turn off state so that the storage capacitor Cst maintains the voltage charged in the scan period. The second transistor M2 is included in each of the pixels 140.

When a high level voltage is supplied to the first power source ELVDD, the first transistor M1 is turned on. The first transistor M1 supplies current, corresponding to the voltage applied at the first node N1 to the OLED. Therefore, for the emission period, the OLED generates light with predetermined brightness to correspond to the data signal.

The pixel 140, according to the present embodiments, includes two transistors M1 and M2 and a capacitor Cst. The capacitor Cst compensates for the threshold voltage of the driving transistor M1.

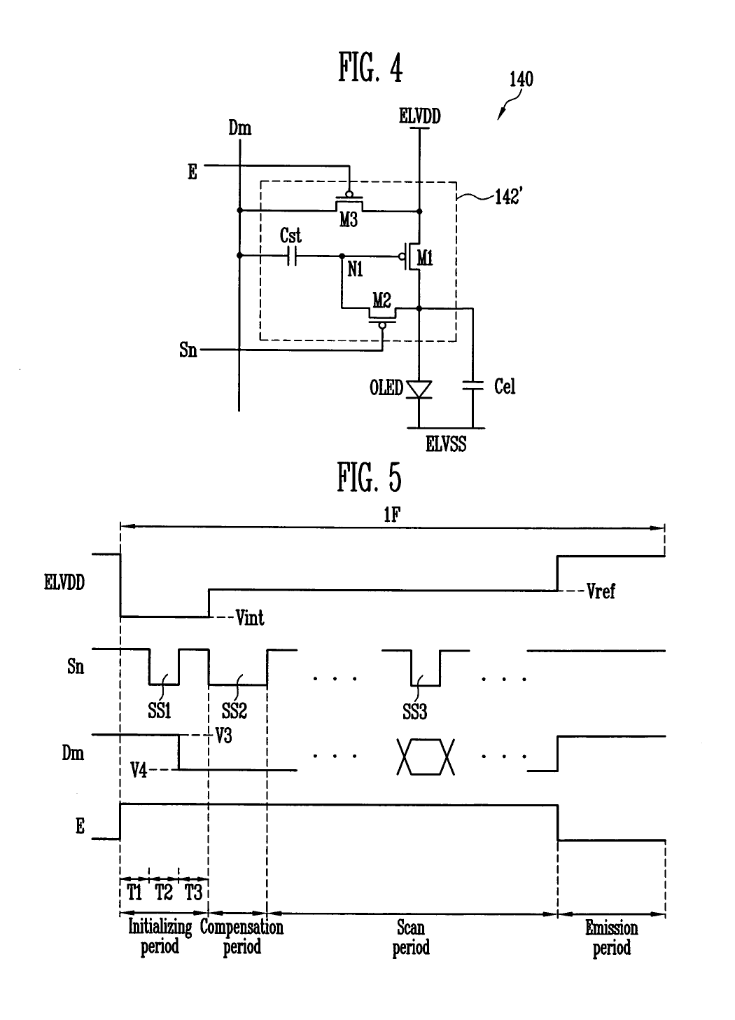

FIG. 4 illustrates a pixel according to a second embodiment. In FIG. 4, the same elements as those of FIG. 3 are denoted by the same reference numerals and detailed description thereof will be omitted.

Referring to FIG. 4, the pixel 140, according to the second embodiment, includes an OLED and a pixel circuit 142′, coupled to the data line Dm and the scan line Sn to control the amount of current supplied to the OLED.

The pixel circuit 142′ includes a third transistor M3 coupled between a first power source ELVDD and the data line Dm. The third transistor M3 is turned off when an emission control signal is supplied to an emission control line E. In other scenarios, the third transistor M3 is turned on. The emission control line E is commonly coupled to all of the pixels 140 and receives an emission control signal from the scan driver 110.

FIG. 5 is a waveform chart illustrating a method of driving the pixel of FIG. 4. FIG. 5 will be described based on differences from FIG. 3.

Referring to FIG. 5, according to the present embodiments, one frame 1F is divided into an initializing period, a compensation period, a scan period, and an emission period. The initializing period is where the voltage of a first node N1 is initialized. The compensation period is where the threshold voltage of the first transistor M1 is compensated for. The scan period is where the voltages corresponding to data signals are charged. The emission period is where light components corresponding to the data signals are generated.

For the initializing period, the compensation period, and the scan period, an emission control signal is supplied to the emission control line E. When the emission control signal is supplied to the emission control line E, the third transistor M3 maintains a turn off state.

For the emission period, supplying the emission control signal to the emission control line E is stopped. When supplying of the emission control signal to the emission control line E is stopped, the third transistor M3 is turned on. When the third transistor M3 is turned on, the voltage of the first power source ELVDD is supplied to the data line Dm. When the voltage of the first power source ELVDD is supplied to the data line Dm, the voltage of the first node N1 changes to correspond to the voltage of the first power source ELVDD. Thus, an image with desired brightness may be displayed regardless of the voltage reduction of the first power source ELVDD.

The voltage reduction of the first power source ELVDD corresponds to the position of the pixel 140 in the pixel unit 130. Therefore, in the case of the pixel 140, according to the first embodiment, a partially non-uniform image may be displayed to correspond to the voltage reduction of the first power source ELVDD. According to the second embodiment, when the voltage of the first power source ELVDD is supplied to the data line Dm, the voltage of the first node N1 changes to correspond to the first power source ELVDD. Thus, an image with desired brightness may be displayed, regardless of the voltage reduction of the first power source ELVDD. For the emission period, since the data line Dm is used as an auxiliary power source line for supplying the voltage of the first power source ELVDD, the voltage of the first power source ELVDD may be reduced.

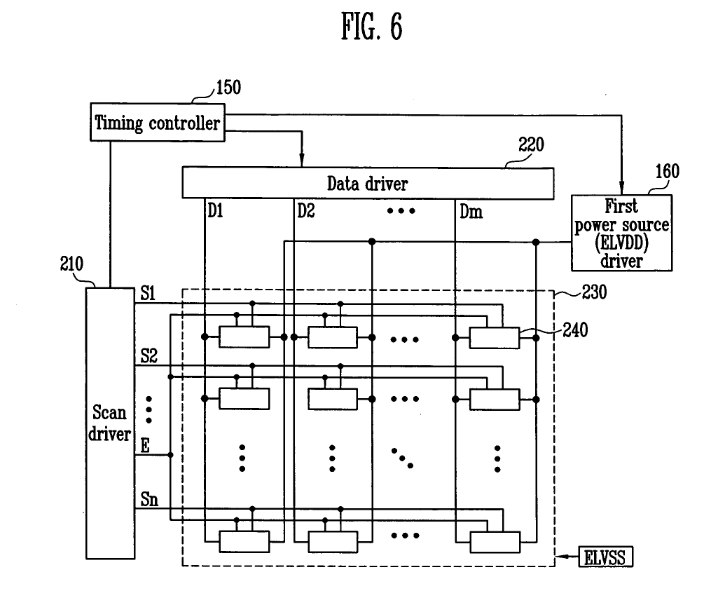

FIG. 6 illustrates an organic light emitting display according to another embodiment. In FIG. 6, the same elements as those of FIG. 1 are denoted by the same reference numerals, and detailed description thereof will be omitted.

Referring to FIG. 6, the organic light emitting display, according to the embodiment, includes a pixel unit 230. The pixel unit 230 includes pixels 240, a scan driver 210 for driving the scan lines S1 to Sn and the emission control line E, a data driver 220 for driving the data lines D1 to Dm, a first power source driver 160 for applying the first power source ELVDD to the pixels 240, and a timing controller 150 for controlling the drivers 210, 220, and 160. The pixels 240 are positioned at the intersections of the scan lines S1 to Sn, the data lines D1 to Dm, and the emission control line E.

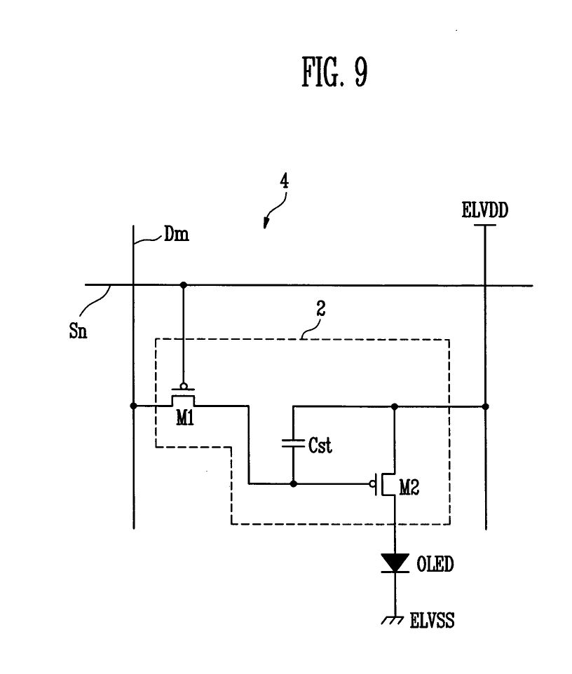

As illustrated in FIG. 8, the scan driver 210 supplies the first scan signal SS1, the second scan signal SS2, and the third scan signal SS3 to the scan lines S1 to Sn. The scan driver 210 supplies an emission control signal to the emission control line E for a first period T1 and a second period T2 of the initializing period, a compensation period, and a scan period. For the third period T3 of the initializing period, the emission control signal is not supplied to the emission control line E.

The data driver 220 supplies data signals to the data lines D1 to Dm for the scan period, in synchronization with the third scan signal SS3. Then, the data driver 220 supplies a third voltage V3 to the data lines D1 to Dm for the second period T2 of the initializing period. The data driver 220 also supplies a fourth voltage V4 to the data lines D1 to Dm for a first period T1 and a third period T3.

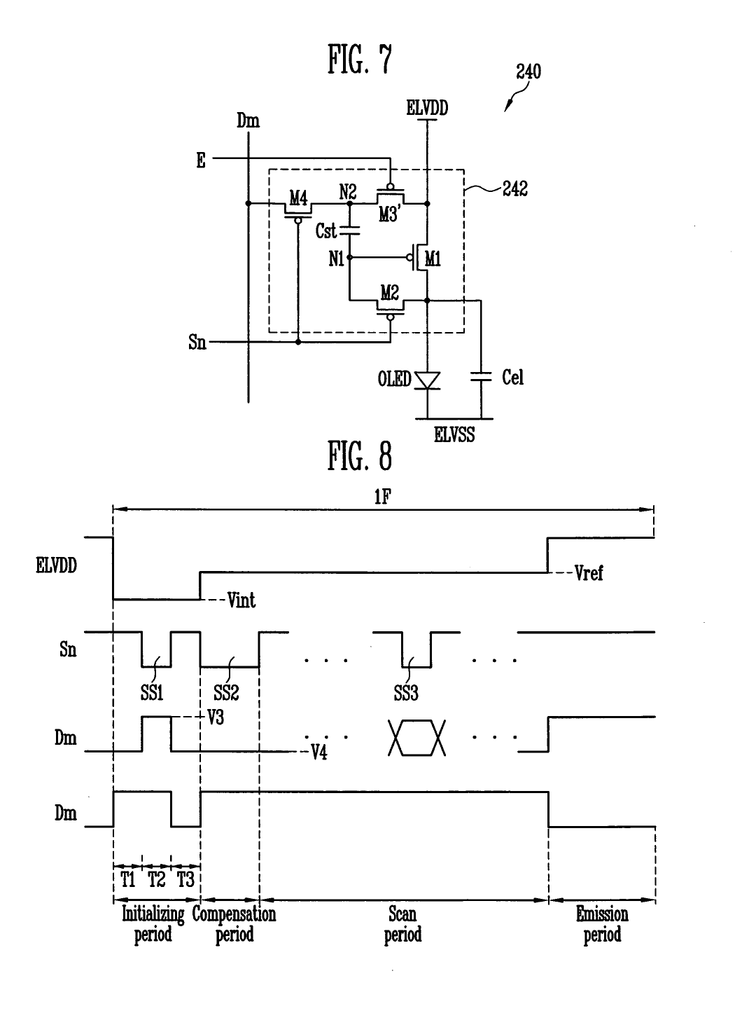

FIG. 7 illustrates an embodiment of the pixel of FIG. 6. In FIG. 7, the same elements as those of FIGS. 2 and 4 are denoted by the same reference numerals, and detailed description thereof will be omitted.

Referring to FIG. 7, a pixel 240, according to an embodiment, includes an OLED and a pixel circuit 242. The pixel circuit 242 is coupled to the data line Dm, the scan line Sn, and the emission control line E to control the amount of current supplied to the OLED.

The pixel circuit 242 controls the amount of current supplied to the OLED. The pixel circuit 242 includes first to fourth transistors M1 to M4 and a storage capacitor Cst.

The storage capacitor Cst is coupled between a first node N1 and a second node N2. The storage capacitor Cst charges the voltages corresponding to data signals and the threshold voltage of the first transistor M1.

The first electrode of the first transistor M1 is coupled to the first power source ELVDD. The second electrode of the first transistor M1 is coupled to the OLED. The gate electrode of the first transistor M1 is coupled to the first node N1. The first transistor M1 supplies current to the OLED, corresponding to the voltage applied to the first node N1.

The first electrode of the second transistor M2 is coupled to the second electrode of the first transistor M1. The second electrode of the second transistor M2 is coupled to the first node N1. The gate electrode of the second transistor M2 is coupled to the scan line Sn. The second transistor M2 is turned on when a scan signal is supplied to the scan line Sn. The scan signal is supplied to the scan line Sn to electrically couple the first node N1 to the second electrode of the first transistor M1.

A third transistor M3′ is coupled between a first power source ELVDD and the second node N2. The gate electrode of the third transistor M3′ is coupled to the emission control line E. The third transistor M3′ is turned off when an emission control signal is supplied to the emission control line E. The third transistor M3′ is turned on when the emission control signal is not supplied.

The first electrode of the fourth transistor M4 is coupled to the data line Dm. The second electrode of the fourth transistor M4 is coupled to the second node N2. The gate electrode of the fourth transistor M4 is coupled to the scan line Sn. The fourth transistor M4 is turned on when the scan signal is supplied to the scan line Sn.

FIG. 8 is a waveform chart illustrating a method of driving the pixel of FIG. 7.

Referring to FIG. 8, for the first period T1 of the initializing period, the initializing voltage Vint is supplied as the first power source so that the OLED is set to be in a non-emission state.

For the second period T2 of the initializing period, the first scan signal SS1 is simultaneously supplied to the scan lines S1 to Sn. The third voltage V3 is supplied to the data line Dm for the second period T2.

When the first scan signal SS1 is supplied to the scan line Sn, the second transistor M2 and the fourth transistor M4 are turned on. When the second transistor M2 is turned on, the voltage of the anode electrode of the OLED is supplied to the first node N1. Since the OLED is set to be in an off state for the initializing period, the off voltage of the OLED is supplied to the first node N1.

When the fourth transistor M4 is turned on, the second node N2 and the data line Dm are electrically coupled to each other. The data line Dm are electrically coupled to each other so that the third voltage V3 is supplied to the second node N2. For the second period T2, the storage capacitor Cst charges the voltage corresponding to a difference between the first node N1 and the second node N2.

For the third period T3 of the initializing period, supplying the emission control signal to the emission control line E is stopped. When supplying of the emission control signal to the emission control line E is stopped, the third transistor M3′ is turned on. When the third transistor M3′ is turned on, the voltage of the second node N2 is reduced from the third voltage V3 to the voltage of the initial power source Vint. The voltage of the first node N1 is reduced to correspond to the voltage change of the second node N2. A voltage difference between the third voltage V3 and the initial power source Vint is set so that the first transistor M1 may be turned on by the voltage of the first node N1.

When the voltage of the first node N1 is reduced, the first transistor M1 is turned on. When the first transistor M1 is turned on, the initializing voltage Vint is supplied to the anode electrode of the OLED. Thus, the initializing voltage Vint is charged in the parasitic capacitor Cel.

For the compensation period, the second scan signal SS2 is simultaneously supplied to the scan lines S1 to Sn. Then, for the compensation period, the voltage of the reference power source Vref is supplied to the first power source ELVDD. When the second scan signal SS2 is supplied to the scan line Sn, the second transistor M2 and the fourth transistor M4 are turned on.

When the fourth transistor M4 is turned on, the data line Dm and the second node N2 are electrically coupled to each other. For the compensation period, the fourth voltage V4 (i.e., the same voltage as the initializing voltage Vint) supplied to the data line Dm is applied to the second node N2. When the second transistor M2 is turned on, the first node N1 and the anode electrode of the OLED are electrically coupled to each other.

Since the reference power source Vref to the first power source ELVDD is not supplied, the voltage of the first node N1 increases from the initializing voltage Vint to the voltage obtained by subtracting the threshold voltage of the first transistor M1 from the reference power source Vref. The storage capacitor Cst charges a predetermined voltage to correspond to the voltage applied to the first node N1.

For the scan period, the third scan signal SS3 is sequentially supplied to the scan lines S1 to Sn. Data signals are supplied to the data lines D1 to Dm to correspond to the third scan signal SS3.

When the third scan signal SS3 is supplied to the nth scan line Sn, the second transistor M2 and the fourth transistor M4 are turned on. When the fourth transistor M4 is turned on, the data signal from the data line Dm is supplied to the second node N2. When the second transistor M2 is turned on, the first node N1 and the anode electrode of the OLED are electrically coupled to each other.

For the scan period, the voltage of the second node N2 changes from the fourth voltage V4 into the voltage of the data signal. The voltage of the first node N1 changes as referenced in Equation 1.

For the emission period, a higher level voltage than the reference power source Vref is supplied to the first power source ELVDD. For the emission period, supplying the emission control signal to the emission control line E is stopped.

When supplying the emission control signal to the emission control line E is stopped, the third transistor M3′ is turned on. The third transistor M3′ is turned on so that the high level first power source ELVDD is supplied to the second node N2. The voltage of the first node N1 changes to correspond to the voltage of the first power source ELVDD. The first node N1 is set to be in a floating state for the emission period. Thus, for the scan period, the voltage charged in the storage capacitor Cst does not change.

When a high level voltage is supplied to the first power source ELVDD, the first transistor M1 is turned on. The first transistor M1 supplies current corresponding to the voltage applied to the first node N1 to the OLED. Therefore, for the emission period, the OLED generates light with predetermined brightness.

FIG. 9 illustrates a pixel of a conventional OLED.

Referring to FIG. 9, a pixel 4 of an organic light emitting display includes an organic light emitting diode OLED and a pixel circuit 2. The pixel circuit 2 is coupled to a data line Dm and a scan line Sn to control the OLED.

The anode electrode of the OLED is coupled to the pixel circuit 2. The cathode electrode of the OLED is coupled to a second power source ELVSS. The OLED emits light with predetermined brightness, in response to current supplied from the pixel circuit 2.

When a scan signal is supplied to the scan line Sn, the pixel circuit 2 controls the amount of current supplied to the OLED in response to the data signal supplied to the data line Dm. The pixel circuit 2 includes a second transistor M2 coupled between a first power source ELVDD and the OLED, a first transistor M1, and a storage capacitor. The first transistor M1 is coupled to the second transistor M2, the data line Dm, and the scan line Sn. The storage capacitor C is coupled between the gate electrode of the second transistor M2 and the first electrode of the second transistor M2.

The gate electrode of the first transistor M1 is coupled to the scan line Sn. The first electrode of the first transistor M1 is coupled to the data line Dm. The second electrode of the first transistor M1 is coupled to one terminal of the storage capacitor C. The first electrode of the first transistor M1 is set as either a source electrode or a drain electrode. The second electrode of the first transistor M1 is set as the other type of electrode. For example, when the first electrode of the first transistor M1 is set as the source electrode, the second electrode of the first transistor M1 is set to the drain electrode. The first transistor M1 is coupled to the scan line Sn and the data line Dm. The first transistor M1 is turned on when the scan signal is supplied from the scan line Sn. The first transistor M1 supplies the data signal from the data line Dm to the storage capacitor C. The storage capacitor C charges voltage corresponding to the data signal.

The gate electrode of the second transistor M2 is coupled to an electrode of the storage capacitor C. The first electrode of the second transistor M2 is coupled to the other electrode of the storage capacitor C and the first power source ELVDD. The second electrode of the second transistor M2 is coupled to the anode electrode of the OLED. The second transistor M2 controls the amount of current supplied from the first power source ELVDD to the second power source ELVSS, via the OLED. The second transistor M2 controls the amount of current supplied in response to the voltage stored in the storage capacitor C. The OLED generates light corresponding to the amount of current from the second transistor M2.

The pixels 4 of the conventional organic light emitting display may not display an image with uniform brightness. The threshold voltages of the second transistors M2 included in the pixels 4, i.e., the driving transistors, are set to vary or deviate. When the threshold voltages of the driving transistors are set to vary, different brightness components are generated by a difference in the threshold voltages of the driving transistors. Even though the data signals corresponding to the same gray scale are supplied to the plurality of pixels 4, there are differences in brightness components.

In order to solve the brightness component problem in the conventional OLED, a configuration of additional transistors in each of the pixels 4 has been suggested to compensate for the threshold voltages of the driving transistors. A configuration, in which six transistors and a capacitor are used for each of the pixels 4 to compensate for the threshold voltages of the driving transistors, has been published in Korean Patent Publication No. 2007-0083072. However, when the six transistors are included in each of the pixels 4, the pixels 4 become complicated and prone to error. Due to the plurality of transistors included in the pixels 4, the possibility of erroneous operation increases.

The present embodiments are directed to an organic light emitting display capable of simplifying the structure and of compensating for the threshold voltages of driving transistors.

In the organic light emitting display, according to the present embodiments, a pixel may include no more than four transistors. The organic light emitting display may compensate for the threshold voltage of a driving transistor. When a small number of transistors are included in the pixel, process yield improves and an aperture ratio increases.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the inventive concept as set forth in the following claims.

What is claimed is:

1. An organic light emitting display, in which one frame is divided into an initializing period, a compensation period, a scan period, and an emission period, the organic light emitting display comprising:
pixels at intersections of scan lines and data lines, the pixels coupled to a first power source and a second power source;
a scan driver simultaneously supplying scan signals to the scan lines for a partial period of the initializing period, the scan driver simultaneously supplying scan signals to the scan lines for the compensation period, and the scan driver sequentially supplying scan signals to the scan lines for the scan period;
a data driver supplying data signals to the data lines in synchronization with the scan signals supplied for the scan period; and
a first power source driver supplying the first power source, the first power source having different voltage levels for the initializing period, the scan period, and the emission period.

2. The organic light emitting display as claimed in claim 1, wherein each of the pixels comprises:
an organic light emitting diode with a cathode electrode coupled to the second power source;
a first transistor for controlling an amount of current that flows from the first power source to the second power source via the OLED;
a second transistor coupled between a gate electrode of the first transistor and the OLED, the second transistor turned on when a scan signal is supplied to a scan line; and
a storage capacitor coupled between the gate electrode of the first transistor and a data line.

3. The organic light emitting display as claimed in claim 2, wherein:
the first power source driver supplies an initializing voltage to the first power source so that the pixels may be set to be in a non-emission state for the initializing period,
the first power source driver supplies a higher reference voltage than the initializing voltage for the compensation period and the scan period, and
the first power source driver supplies a higher level voltage than the reference voltage so that the pixels may be set to be in an emission state for the emission period.

4. The organic light emitting display as claimed in claim 2, wherein:
the initializing period is divided into a first period, a second period, and a third period, and
the data driver supplies a third voltage to data lines for a first period and a second period of the initializing period, the data driver supplies a fourth voltage, lower than a third voltage, for the third period.

5. The organic light emitting display as claimed in claim 4, wherein a voltage difference between the third voltage and the fourth voltage is set so that the first transistor may be turned on.

6. The organic light emitting display as claimed in claim 4, wherein the fourth voltage is set to be equal to or lower than a data signal.

7. The organic light emitting display as claimed in claim 4, wherein the data driver supplies the third voltage to the data lines for the emission period.

8. The organic light emitting display as claimed in claim 4, wherein the data driver sets the data lines in a floating state for the emission period.

9. The organic light emitting display as claimed in claim 4, wherein the scan driver simultaneously supplies scan signals to scan lines for the second period.

10. The organic light emitting display as claimed in claim 2, each of the pixels further comprising:
an emission control line commonly coupled to the pixels.

11. The organic light emitting display device as claimed in claim 10, each of the pixels further comprising:
a third transistor coupled between the first power source and the data line,
the third transistor turned off when an emission control signal is supplied to the emission control line, and
the third transistor turned on in the other cases.

12. The organic light emitting display device as claimed in claim 10, wherein the scan driver supplies an emission control signal to the emission control line for the initializing period, the compensation period, and the scan period.

13. The organic light emitting display as claimed in claim 10, each of the pixels further comprising:
a third transistor coupled between the storage capacitor and the first power source, the third transistor turned off when an emission control signal is supplied to the emission control line; and
a fourth transistor coupled between the storage capacitor and the data line, the fourth transistor turned on when the scan signal is supplied.

14. The organic light emitting display as claimed in claim 13, wherein:
the initializing period is divided into a first period, a second period, and a third period, and
the data driver supplies a third voltage for the second period of the initializing period, the data driver supplies a fourth voltage, lower than the third voltage, for the first period and the second period.

15. The organic light emitting display as claimed in claim 14, wherein the scan driver supplies an emission control signal to the emission control line for the first period and the second period of the initializing period, the compensation period, and the scan period.
